(19) United States
(12) Patent Application Publication
(10) Pub. No.: US 2005/0136763 A1
(43) Pub. Date: Jun. 23, 2005

(54) Industrial fabric having a layer of a fluoropolymer and method of manufacture

(76) Inventor: Dana Eagles, Sherborn, MA (US)

Correspondence Address: FROMMER LAWRENCE & HAUG, 745 FIFTH AVENUE- 10TH FL., NEW YORK, NY, 10151, US

(21) Appl. No.: 10/740,126

(22) Filed: Dec. 17, 2003

(51) Int. Cl. B32B 5/02; B32B 27/04; B32B 27/12; D03D 15/00; B32B 5/26; B05D 3/12; D03D 25/00

(52) U.S. Cl. 442/94; 442/381; 427/365; 427/366

(57) ABSTRACT

The present invention is directed to an industrial fabric that is rendered contamination resistant and maintains good permeability as a result of a durable anti-contaminate material that lasts the entire life of the fabric. A fluoropolymer material will render the fabric contamination resistant over the entire fabric lifetime.

### BACKGROUND OF THE INVENTION

1. Field of the Invention

The present invention relates primarily to the papermaking arts. Specifically, the present invention relates to fabrics for use on papermaking machines, in addition to other industrial applications. More specifically, the present invention relates to fabrics used as industrial process fabrics in the production of, among other things, wet laid products such as paper, paper board, and sanitary tissue and towel products; in the production of wet laid and dry laid pulp; in processes related to papermaking such as those using sludge filters, and chemiwashers; in the production of tissue and towel products made by through-air drying processes; and in the production of non-wovens produced by hydroentangling (wet process), melt blowing, spunbonding, and air laid needle punching. Such industrial process fabrics include but are not limited to non-woven felts; embossing, conveying, and support fabrics used in processes for producing non-wovens; filtration fabrics and filtration cloths. The term “industrial fabrics” also includes but is not limited to all other paper machine fabrics (forming, pressing and dryer fabrics) for transporting the pulp slurry through all stages of the papermaking process. In particular, the present invention is related to fabrics for use as paper machine clothing or as a component in paper machine clothing, such as forming, press and dryer fabrics.

2. Description of the Prior Art

During the papermaking process, a cellulosic fibrous web is formed by depositing a fibrous slurry, that is, an aqueous dispersion of cellulose fibers, onto a moving forming fabric in the forming section of a paper machine. A large amount of water is drained from the slurry through the forming fabric, leaving the cellulosic fibrous web on the surface of the forming fabric.

The newly formed cellulosic fibrous web proceeds from the forming section to a press section, which includes a series of press nips. The cellulosic fibrous web passes through the press nips supported by a press fabric, or, as is often the case, between two such press fabrics. In the press nips, the cellulosic fibrous web is subjected to compressive forces which squeeze water therefrom, and which adhere the cellulosic fibers in the web to one another to turn the cellulosic fibrous web into a paper sheet. The water is accepted by the press fabric or fabrics and, ideally, does not return to the paper sheet.

The paper sheet finally proceeds to a dryer section, which includes at least one series of rotatable dryer drums or cylinders, which are internally heated by steam. The newly formed paper sheet is directed in a serpentine path sequentially around each in the series of drums by a dryer fabric, which holds the paper sheet closely against the surfaces of the drums. The heated drums reduce the water content of the paper sheet to a desirable level through evaporation.

It should be appreciated that the forming, press and dryer fabrics all take the form of endless loops on the paper machine and function in the manner of conveyors. It should further be appreciated that paper manufacture is a continuous process which proceeds at considerable speeds. That is to say, the fibrous slurry is continuously deposited onto the forming fabric in the forming section, while a newly manufactured paper sheet is continuously wound onto rolls after it exits from the dryer section.

The present invention relates specifically to the press fabrics used in the press section. Press fabrics play a critical role during the paper manufacturing process. One of their functions, as implied above, is to support and to carry the paper product being manufactured through the press nips.

Press fabrics also participate in the finishing of the surface of the paper sheet. That is, press fabrics are designed to have smooth surfaces and uniformly resilient structures, so that, in the course of passing through the press nips, a smooth, mark-free surface is imparted to the paper.

Perhaps most importantly, the press fabrics accept the large quantities of water extracted from the wet paper in the press nip. In order to fill this function, there literally must be space, commonly referred to as void volume, within the press fabric for the water to go, and the fabric must have adequate permeability to water for its entire useful life. Finally, press fabrics must be able to prevent the water accepted from the wet paper from returning to and rewetting the paper upon exit from the press nip.

Contemporary press fabrics are produced in a wide variety of styles designed to meet the requirements of the paper machines on which they are installed for the paper grades being manufactured. Generally, they comprise a woven base fabric into which has been needled a batt of fine, non-woven fibrous material. The base fabrics may be woven from monofilament, plied monofilament, multifilament or plied multifilament yarns, and may be single-layered, multi-layered or laminated. The yarns are typically extruded from any one of several synthetic polymeric resins, such as polyamide and polyester resins, used for this purpose by those of ordinary skill in the paper machine clothing arts.

The woven base fabrics themselves take many different forms. For example, they may be woven endless, or flat woven and subsequently rendered into endless form with a woven seam. Alternatively, they may be produced by a process commonly known as modified endless weaving, wherein the widthwise edges of the base fabric are provided with seaming loops using the machine-direction (MD) yarns thereof. In this process, the MD yarns weave continuously back and forth between the widthwise edges of the fabric, at each edge turning back and forming a seaming loop. A base fabric produced in this fashion is placed into endless form during installation on a paper machine, and for this reason is referred to as an on-machine-seamable fabric. To place such a fabric into endless form, the two widthwise edges are brought together, the seaming loops at the two edges are interdigitated with one another, and a seaming pin or pintle is directed through the passage formed by the interdigitated seaming loops.

Further, the woven base fabrics may be laminated by placing one base fabric within the endless loop formed by another, and by needling a staple fiber batt through both base fabrics to join them to one another. One or both woven base fabrics may be of the on-machine-seamable type.

In any event, the woven base fabrics are in the form of endless loops, or are seamable into such forms, having a specific length, measured longitudinally therearound, and a specific width, measured transversely there across. Because paper machine configurations vary widely, paper machine clothing manufacturers are required to produce press fabrics, and other paper machine clothing, to the dimensions required to fit particular positions in the paper machines of their customers. Needless to say, this requirement makes it difficult to streamline the manufacturing process, as each press fabric must typically be made to order.

In response to this need to produce press fabrics in a variety of lengths and widths more quickly and efficiently, press fabrics have been produced in recent years using a spiral technique disclosed in commonly assigned U.S. Pat. No. 5,360,656 to Rexfelt et al., the teachings of which are incorporated herein by reference.

U.S. Pat. No. 5,360,656 shows a press fabric comprising a base fabric having one or more layers of staple fiber material needled thereinto. The base fabric comprises at least one layer composed of a spirally wound strip of woven fabric having a width which is smaller than the width of the base fabric. The base fabric is endless in the longitudinal, or machine, direction. Lengthwise threads of the spirally wound strip make an angle with the longitudinal direction of the press fabric. The strip of woven fabric may be flat-woven on a loom which is narrower than those typically used in the production of paper machine clothing.

Regardless of the application or the manner in which the formed, fabrics must exhibit characteristics specific to the dewatering function, such as (1) receiving the large amount of water pressed from the paper furnish in the press nip, (2) releasing water to a vented press roll on the opposite or non sheetside of the press fabric, (3) releasing water to an auxiliary suction dewatering apparatus, and (4) remaining permeable so that both water and air can flow into and through the fabric.

The degree of openness of a fabric is continually reduced during its lifetime. In addition to the fiber slurry, paper pulp ordinarily contains additives such as filler clay, pitch, and polymeric materials that clog the open spaces of the fabric. The use of recycled fibers has introduced considerable amounts of contaminants in the form of inks, adhesives, tars, and polymeric materials, which also clog the open spaces of the fabric. In addition, fabrics are sometimes constructed of multiple layers that are more susceptible to contamination problems.

Accordingly, fabrics that exhibit an improved degree of contamination resistance are desirable. One proposed prior art solution is the use of contamination resistant yarns in the construction of the fabric. This has not proved to be wholly satisfactory since the contamination resistance provided by such yarns is short-lived and/or ineffective. Another proposed solution calls for coating or treating papermaking fabrics in order to improve resistance to contaminants. Again, this method is not wholly successful because the contamination resistance provided by the coating is short-lived and/or ineffective.

One problem generally inherent to coatings or treatments is that coatings per se are known to reduce the permeability of a fabric, an undesired result that inhibits water removal capabilities, the primary function of a papermaker's fabric. It is therefore important that any coating applied to a fabric reduce permeability as little as possible.

U.S. Pat. Nos. 5,207,873 and 5,395,868 describe papermaking fabrics claimed to have permanent resistance to adhesion of contaminants. The fabrics are coated with solutions having as their primary components tetrafluoroethylene, urethane copolymer and polyacrylamide.

However, one of the difficulties in applying or using such anti-contaminant materials is positioning the anti-contaminant material in the structure such that they perform their function in an optimized fashion. For example, if an anti-contaminant material is dispersed throughout the cross-section of a monofilament during extrusion, one finds that the anti-contaminant material which is contained within the body of the monofilament does not provide any useful anti-soiling function. Anti-contaminant materials which reside at the surface of the as-produced monofilament or at an abraided surface are found to provide good anti-soiling function while anti-contaminant materials contained in the interior of a monofilament may provide function only when they are exposed through abrasion. A significant portion of the anti-contaminant material contained within the monofilament never sees practical use as it never becomes exposed to the surface during fabric wear. In addition to this non-optimal use of anti-contaminant materials, the high cost of anti-contaminant materials relative to the base materials typically used to produce monofilaments for paper machine clothing and related applications contributes to high product cost relative to product performance or benefit.

The present invention is directed to a contamination resistant press fabric and a method for forming such a press fabric that overcomes the shortcomings of the prior art.

### SUMMARY OF THE INVENTION

It is an object of the present invention to provide an industrial fabric used in the production of a paper, tissue or towel, processes related to paper making such as pulp dewatering, sludge dewatering and machinery producing nonwoven products that exhibits an improved resistance to contamination over the entire life of the fabric.

It is a further object of the invention to provide a fabric processed in a manner that optimizes the benefits realized by the application of an anti-contaminant material, while minimizing the amount of such material.

It is a further object of the invention to provide a layer of which does not significantly affect the permeability of the fabric.

It is a further object of the present invention to provide a layer for a fabric used in the production of a paper, tissue or towel, processes related to papermaking such as pulp dewatering, sludge dewatering and machinery producing nonwovens products that achieves the aforementioned objectives.

The present invention is a fabric used in a papermaking machine and other industrial applications that has an enhanced resistance to contamination which lasts over the entire fabric lifetime.

One embodiment of the present invention is a method of forming an industrial fabric. The method includes the steps of providing a base structure, needling a layer of staple fibers into the base structure, calendaring the base structure with the staple fiber layer, and then applying to the resulting surface a fluoropolymer. The fluoropolymer is then heated above its melting point to bond the fluoropolymer to this structure.

In another embodiment, the present invention is directed to an industrial fabric formed of a base structure, and a layer of fluoropolymer applied to the base structure. The fluoropolymer is heated and bonded to the base structure, providing a fabric with enhanced anti-containment characteristics.

A further embodiment of the present invention is an intermediate industrial fabric structure for constructing a finished fabric. The intermediate papermaker's fabric includes a strip of base structure having a width that is less than the width of a finished fabric. The intermediate fabric may also include a layer of fibrous batt attached to the strip of base structure which is also calendered and a fluoropolymer layer applied to fibrous batt and the base structure. The fluoropolymer is also heated above its melting point and bonded to the base structure and/or the fibrous batt. It should however, be understood that in certain instances the fluoropolymer may have a melting point higher than the base structures. In such a case, care should be taken to avoid having heat energy penetrate too extensively into the base structure which would result in an undesired fusion of the base structure.

By practicing the construction techniques taught by U.S. Pat. No. 5,360,656, the strips of the intermediate fabric structure can be placed side by side, with the edges of the strips being joined together. Preferably, the strips have a width of 0.5 m-1.5 m. The number of strips laid side by side depends on the desired width of the finished fabric. Once the structure has been formed at its desired width, additional layers of fibrous batt can be applied to the fabric and attached thereto, such as by needling, adhesive bonding, or the techniques known to those in the art.

It should be understood that very long lengths of the narrow strips of intermediate fabric can be formed and placed onto feeder rolls. By feeding out the strips from the rolls, and wrapping the strips in a side-by-side arrangement around parallel axes set at preselected distance from each other, it is possible to produce an individual fabric having the desired final dimensions.

By applying the fluoropolymer to the strips of intermediate fabric, the present invention avoids any problems that may be associated with the limited pot-life of the fluoropolymer and any disposal problems of the unused material. The application width has been significantly reduced, which reduces the dimensions of the apparatus. As a result of these modifications, an improved degree of control of the application as well as reduced process costs is realized.

Suitable fluropolymers include polytetrafluoroethylene (PTFE), polyvinylideneflouride (PVDF), polyethylene chlorotrifluoroethylene (PECTFE), and others sold under the trade name Teflon® (DuPont).

It has been observed in certain types of fabrics having a layer of batt, like press fabrics, that a large portion of polymeric contaminants that reduce void volume, and hence water removal, are often concentrated in the interior of the structure on top of the base structure. It is generally believed that in operation on a paper machine, the cleanliness of the outer batt layer of the press fabric is maintained by the mechanical energy provided by high pressure cleaning showers, which energy dissipates rapidly through the thickness of the fabric. The interior batt layer, which is really an interfacial region between two fabric components of different specific surface (base yarns and staple fibers), is subject to substantially less mechanical energy from the showers than the upper fabric regions are subjected to. Thus, cohesive forces which cause the agglomeration of the various gels and chemical species, and adhesive forces that attach them to the fabric, are not disrupted sufficiently in the lower interior fabric regions to prevent their formation. It is believed that this phenomena has not been accounted for by prior art attempts at improving contamination resistance. It is also believed that by positioning the fluoropolymer material on or near the base layer, the fabric will possess an excellent degree of contamination resistance at the place where it is needed most.

The various features of novelty which characterize the invention are pointed out in particularity in the claims annexed to and forming a part of this disclosure. For a better understanding of the invention, its operating advantages and specific objects attained by its uses, reference is made to the accompanying descriptive matter in which preferred embodiments of the invention are illustrated.

### BRIEF DESCRIPTION OF THE FIGURE

FIG. 1 is a cross-section view of an industrial fabric according to one embodiment of the present invention.

### DETAILED DESCRIPTION OF THE PREFFERED EMBODIMENTS

There are a variety of industrial fabrics for applications ranging from papermaking, hydroentangling, spunbond and meltblowing, to dry filtration and wet filtration. In many applications, the incorporation of a fluoropolymer material into the textile structure has been shown to provide an improved product. For example, fluoropolymers have been incorporated into monofilaments comprised predominantly of polyester. When these fluoropolymers are incorporated at relatively high loadings (10 percent), the resulting fabric is found to have greater resistance to contamination. This anti-soiling characteristic is valuable to the user since a clean fabric equates to a consistent functioning of the fabric. However, there are shortcomings to this approach.

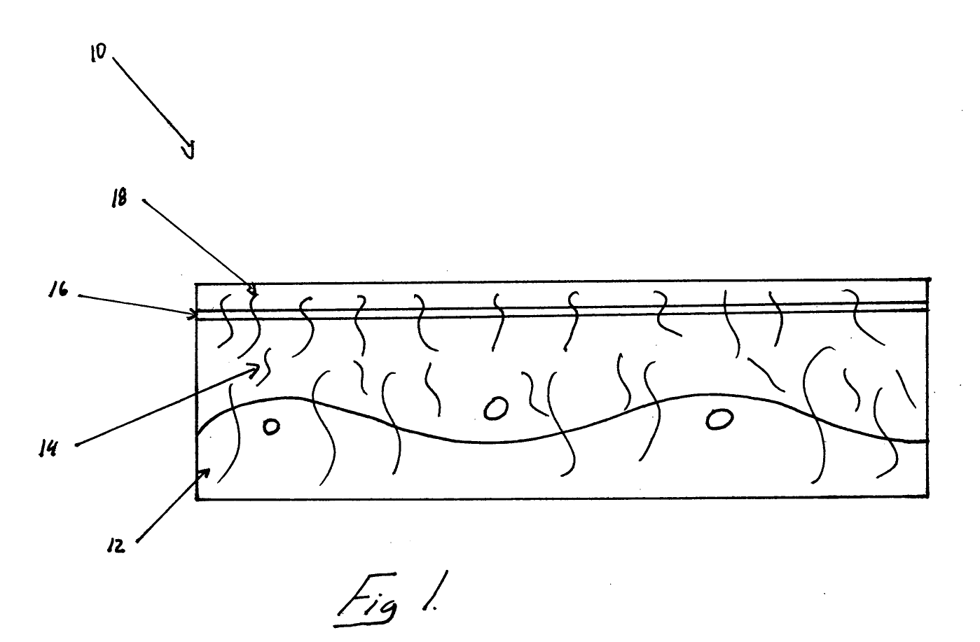

A first embodiment of the present invention is shown in FIG. 1, and comprises a full base fabric structure 12 or layer that has been produced by conventional techniques which has been needled with batt component 14 using conventional needling equipment. Base structure or layer may include woven, and nonwovens such as knitted, extruded mesh, spiral-link, MD and/or CD yarn arrays, and spiral wound strips of woven and nonwoven materials. These substrates may include yarns of monofilament, plied monofilament, multifilament or plied multifilament, and may be single-layered, multi-layered or laminated. The yarns are typically extruded from any one of the synthetic polymeric resins, such as polyamide and polyester resins, metal or other material suitable for the purpose known to those of ordinary skill in the industrial fabric arts.

After this needling is complete, the structure is subjected to gap calendaring or fusion calendaring to produce a glazed-like surface having distinctively different wetability characteristics as compared to the structure prior to fusion or gap calendaring. A fluoropolymer anti-contaminant material 16 is applied to the structure by either the conventional kiss roll/vacuum roll/vacuum slot method, or by metered spray. Other methods may also be used which do not result in a significant portion of the flouropolymer suspension being applied to the interior structure of the fabric.

Suitable fluoropolymers include, but are not limited to polytetrafluoroethylene (PTFE), polyvinylideneflouride (PVDF), polyethylene chlorotrifluoroethylene (PECTFE), and others sold under the trade name Teflon® (DuPont).

After the application of the anti-contaminant material, hot air can be used to speed the drying if necessary. This provides an intermediate fabric structure that has anti-contaminant properties located in the base structure and/or initial layer or layers of fibrous batt.

After the anti-contamination material has been applied to the glazed surface of the fabric and dried, the structure is then subjected to fusion calendaring or gap calendaring. In this step of the process, it is possible to achieve surface temperatures which exceed the melting point of the materials comprising the glazed fabric structure. By exceeding the melting point of these materials, it is possible to fuse the fluoropolymer 16 such that the fluoropoymer 16 becomes bonded to the intermediate fabric and forms a tough, film-like character. The formation of such a film on the surface of this intermediate fabric, is counter-intuitive since one would expect that the conditions necessary to fuse flouropolymer into a tough, film-like material would result in serious and detrimental melting to the glazed fabric.

Note that the fused surface results in localizing the anti-contaminant material, thus minimizing the amount used and thus its effect on the fabric's permeability.

The structure may then be further needled, to include at least one additional layer of fibrous batt 18, and other process steps may also be performed, such as seam opening if required, washing, drying, and final dimensional sizing.

The anti contaminant material formulation may contain 5% to about 50% solids on a weight-weight basis, with a mass add-on of 0.1% to 10.0% based on the weight of the uncoated fabric. The % mass add on is:

$$100 \times \frac{\begin{matrix}( \text{basis weight of a dry,coated fabric} - \\ \text{basis weight of a dry uncoated fabric} )\end{matrix}}{( \text{basis weight of a dry uncoated fabric} ) .}$$

As a general matter, a greater degree of the original permeability of a coated fabric is retained when the solids content of the anti-contaminant material or mass add on of the anti-contaminant material is reduced. Water, a preferred diluent for aqueous based formulatives, may be used to reduce solids content and consequently percent mass add on. It has been found that fabrics having formulations of a solids content in the range of 10% to 15% (w/w) or a mass add on of 1% to 3% maintain a high degree of their original permeability. That is, they maintain about 90%-99% of their original permeability, which is preferred. In other words, permeability is reduced only about 1%-10% as a result of the addition of the anti-contaminant material. The anti-contaminant material can be applied in a single pass, or it may be applied in multiple passes.

A fabric formed by this process is expected to provide superior anti-contaminant or antisoiling properties at the region on or in the fabric. In a similar fashion, it is expected that fluoropolymer surfaces can be created on the surfaces of dry filtration media and other nonwoven materials. In another embodiment of the present invention, PVDF powder could be applied as a thin layer to the top surface of the glazed fabric. Fusion or gap calendaring could then be used to fuse or melt this powder into a cohesive layer on the surface of the fabric. It is important to note in this example and in the previous example, the fluoropolymer layer is not intended to form an impermeable film covering the surface of the textile fabric.

While the above describes what is primarily a press fabric, other type fabrics are also envisioned. For example, fabrics such as those used as forming fabrics or dryer fabrics can be used as the base for fluoropolymer layer. In this case, the fluoropolymer whether applied from a liquid or aqueous suspension or in powder form, is applied to one side of the fabric structure. The entire structure is then subjected to fusion or gap calendaring for the purpose of fusing the fluoropolymer without resulting in serious or detrimental melting of the structure. In this way, it is possible to preferentially apply a fluoropolymer layer to one side of the fabric structure. This is particularly advantageous when it is necessary to use a fluoropolymer which has a higher melting point than the material which comprises the base fabric. As in the first example, fusion calendaring or gap calendaring provides a means to convert high temperature fluoropolymers into tough permeable film-like materials covering a substrate material having a lower melting point while maintaining a permeable structure necessary for the end application.

In a further embodiment a meltblown Halar fabric (Halar is a trade name for PECTFE) can be used to form the anti-contamination layer. In this specific example, a layer of Halar meltblown fabric is fused to the surface of a fabric via fusion calendaring and/or then subjected to fusion calendaring of the Halar surface to provide a glazed fluoropolymer surface to the fabric structure.

In another embodiment of the invention for example for use as a press fabric, a strip of narrow base fabric structure (i.e. a structure that is less than the width of the final fabric that would be used on the papermachine) may be prepared for example by weaving, knitting, spiral winding MD and/or CD yarns arrays or by using an apertured polymeric film. The term “strip” as used herein and in the following relates to a piece of material having an essentially larger length than width. The only upper limit of the strip width is that it should be narrower than the width of the final base fabric. For example the strip width may be 0.5-1.5 m, whereas the finished fabric may be 10 m or wider. A portion of the total batt is attached to the narrow strip of base fabric by needling using conventional needling equipment. After this partial needling is complete, the anti-containment material is applied to the structure by either the conventional kiss roll/vacuum roll/vacuum slot method, or by metered spraying. After the application of the anti-contaminant material, hot air can be used to speed the drying if necessary. After the anti-contamination material has been applied to the glazed surface of the fabric and dried, the structure is then subjected to fusion calendaring or gap calendaring, to fuse the anti-contamination material such that the anti-contamination material becomes bonded to the intermediate fabric and forms a tough, film-like character.

The narrow substrate can be rolled up after this to await later processing. In essence, what has been produced is a partial fabric structure that has anti-contaminant properties in the base structure and/or the initial layer or layers of fibrous web. The partial fabric structure can be used to make a full width fabric according to the teachings of U.S. Pat. No. 5,360,656.

By applying the anti-contaminant material to the partial structure in its “narrow” phase, and knowing the material uptake of the structure and the length of the feedstock, precise consumption of the material can be achieved. This will eliminate the potlife and disposal problems seen with full width material application, as well as placing the material in the most effective (desired) position within the fabric. Other advantages are a reduction in the total amount of material necessary to be effective.

In another embodiment which is similar to the above, the narrow strip of fabric does not have batt applied, rather batt is applied as a later step. In all cases, the anti-contaminant material can be applied in the manner as suggested or in any other manner suitable for the purpose and may take the form of an aqueous or liquid solution, dry powder, meltblown fibers or other forms suitable for the purpose.

Thus the present invention its objects and advantages are realized, and although preferred embodiments have been disclosed and described in detail herein, its scope and objects should not be limited thereby; rather its scope should be determined by that of the appended claims.

1. An industrial fabric comprised of:
a base structure;
at least one layer of a fluoropolymer material applied to the base structure,
wherein the layer of fluoropolymer material is heated above its melting point and bonded to the base structure by fusion or gap calendaring.

2. The fabric of claim 1, wherein the base structure includes a layer of fibrous batt.

3. The fabric of claim 2, wherein the fibrous batt is subjected to fusion or gap calendaring to produce a glazed surface on which is applied the layer of fluoropolymer material.

4. The fabric of claim 1, wherein the fluoropolymer material is a dry powder.

5. The fabric of claim 1, wherein the fluoropolymer material is an aqueous or liquid solution.

6. The fabric of claim 1, wherein the fluoropolymer material is meltblown fiber.

7. The fabric of claim 1, wherein the base structure is a forming, drying pressing or other industrial fabric.

8. The fabric of claim 1, wherein the fused fluoropolymer layer is water permeable.

9. The fabric of claim 1, wherein the base structure is full width and taken from the group consisting essentially of woven, or nonwoven, such as spiral-link, MD and/or CD yarn arrays, knitted, extruded mesh, or base structure material strips which are ultimately spiral wound to form a substrate having a width greater than a width of the strips.

10. The fabric of claim 2 further comprising a second layer of fibrous batt.

11. A method of forming an industrial fabric comprising the steps of:
providing a base structure;
applying to the base structure a layer of fluoropolymer material; and
heating the fluoropolymer material to bond the fluoropolymer material to the base structure by fusion or gap calendaring.

12. The method of claim 11, wherein the base structure includes a layer of fibrous batt.

13. The method of claim 11, wherein the fibrous batt is subjected to fusion or gap calendaring to produce a glazed surface on which the layer of fluoropolymer is applied.

14. The method of claim 11, wherein the fluoropolymer material is a dry powder.

15. The method of claim 11, wherein the fluoropolymer material is an aqueous or liquid solution.

16. The method of claim 11, wherein the fluoropolymer material is meltblown fibers.

17. The method of claim 11, wherein the base structure is a forming, drying, pressing or other industrial fabric.

18. The method of claim 11, wherein the fused fluoropolymer layer is water permeable.

19. The method of claim 12, wherein the layer of a fibrous batt is needled into both sides of the base structure.

20. The method of claim 11, wherein the base structure is full width and taken from the group consisting essentially of woven, or nonwoven, such as spiral-link, MD or CD yarn arrays, knitted, extruded mesh, or base structure material strips which are ultimately spiral wound to form a substrate having a width greater than a width of the strips.

21. The method of claim 12 further comprising the step of needling a second layer of fibrous batt into the first layer of fibrous batt.

22. An intermediate industrial fabric structure for constructing a finished fabric comprising:
a strip of base structure having a width that is less than the width of a finished fabric; and
a fluoropolymer layer of material applied to the base structure, wherein the layer of fluoropolymer material is heated above its melting point and bonded to the base structure by fusion or gap calendaring.

23. The intermediate industrial fabric structure of claim 22 wherein the fabric is comprised of a plurality of intermediate strips of base structures in a side by side arrangement, said intermediate industrial fabric strips being attached to each other at their edges to provide an industrial fabric structure.

24. The intermediate industrial fabric structure of claim 22, wherein the intermediate base structure strip has a length dimension that is greater than the length of the finished industrial fabric.

25. The intermediate industrial fabric structure of claim 23, wherein the intermediate structure is stored on a roll.

26. The intermediate industrial fabric of claim 23, wherein the fabric is constructed of a unitary piece of intermediate base structure that is wound around two parallel rolls set apart from each other at a preselected distance, and wherein the turns of intermediate industrial fabric structure are positioned around said rolls in a side by side arrangement and said edges of the turns are attached to each other.

27. The intermediate industrial fabric of claim 23, wherein a layer of fibrous batt is applied to one or both sides of the base structure.

28. The intermediate papermaker's fabric of claim 22, wherein the base structure is taken from the group consisting essentially of woven, or nonwoven, such as spiral-link, MD and/or CD yarn arrays, knitted or extruded mesh.

29. The intermediate papermaker's fabric of claim 23 further comprising a second layer of fibrous batt.

30. The intermediate papermaker's fabric of claim 27 wherein the fluoropolymer layer is applied to the layer of fibrous batt.

31. The intermediate papermaker's fabric of claim 30 further comprising a second layer of fibrous applied to the first layer of fibrous batt.
